(19) United States
(12) Patent Application Publication
(10) Pub. No.: US 2025/0088339 A1
(43) Pub. Date: Mar. 13, 2025

(54) DYNAMIC INDICATION OF SWITCH DELAY

(71) Applicant: Nokia Technologies Oy, Espoo (FI)

(72) Inventors: Morten TOFT, Svenstrup (DK); Knud KNUDSEN, Aabybro (DK); Jan Torst HVIID, Klarup (DK); Rafael CAUDURO DIAS DE PAIVA, Aalborg (DK); Samantha CAPORAL DEL BARRIO, Aalborg (DK)

(21) Appl. No.: 18/828,104

(22) Filed: Sep. 9, 2024

(30) Foreign Application Priority Data
Sep. 11, 2023 (FI) 20236019

(51) Int. Cl. H04L 5/00

(52) U.S. Cl. CPC H04L 5/0094; H04L 5/0051

(57) ABSTRACT

Embodiments of the present disclosure generally relate to the field of telecommunication and in particular to devices, methods, apparatuses and computer readable storage media for enabling a flexible Indication of switch delay for uplink transmission configuration indicator (TCI) state switching.

### FIELD

Embodiments of the present disclosure generally relate to the field of telecommunication and in particular to devices, methods, apparatuses and computer readable storage media for enabling a flexible Indication of switch delay for uplink transmission configuration indicator (TCI) state switching.

### BACKGROUND

A user equipment (UE) physical layer procedure for uplink power control is defined in the technical specification (TS) 38.213 section 7. The power for PUSCH is depending on the pathloss (PL_{b,f,c}(qa)). The pathloss is defined as the downlink pathloss calculated by the UE using reference signal (RS) index qa, where the qa for obtaining the downlink pathloss estimate is associated with or included in the indicated TCI-State or TCI-UL-State. whenever a new uplink (UL) or joint TCI state is indicated to the UE, the UE will need to estimate the DL RS pathloss for the new indicated TCI state using the associated DL reference signals. The time allowed for the UE to detect, measure and switch to the new UL or joint TCI state is specified in TS 38.133.

### SUMMARY

The scope of protection sought for various example embodiments is set out by the claims. The example embodiments and features, if any, described in this specification that do not fall under the scope of the claims are to be interpreted as examples useful for understanding various embodiments.

In a first aspect, there is provided an apparatus comprising means for causing to receive an indication indicative of a new transmission configuration indicator (TCI) state that is activated; means for causing to receive sample related information associated with the new TCI state; means for causing to receive one or more path loss reference signal, PL-RS, samples based on at least one of the sample related information or the new TCI state; and means for preparing one or more uplink data based on the new TCI state, if the apparatus is ready to transmit the one or more uplink data based on the sample related information and the one or more PL-RS samples.

In a second aspect, there is provided an apparatus comprising means for causing to transmit an indication indicative of a new transmission configuration indicator, TCI, state that is activated; and means for causing to transmit sample related information associated with the new TCI state.

In a third aspect, means for causing to transmit one or more path loss reference signal, PL-RS, samples based on at least one of sample related information or a new TCI state; means for causing to transmit scheduling information on the new TCI state after transmitting the one or more PL-RS samples; and means for receiving one or more uplink data based on the new TCI state.

In a fourth aspect, there is provided a method comprising receiving, by a user device, an indication indicative of a new transmission configuration indicator, TCI, state that is activated; receiving, by the user device, sample related information associated with the new TCI state; receiving, by the user device, one or more path loss reference signal, PL-RS, samples based on at least one of the sample related information or the new TCI state; and preparing, by the user device, one or more uplink data based on the new TCI state, if the apparatus is ready to transmit the one or more uplink data based on the sample related information and the one or more PL-RS samples.

In a fifth aspect, there is provided a method comprising transmitting, by a network node, an indication indicative of a new transmission configuration indicator, TCI, state that is activated; and transmitting, by the network node, sample related information associated with the new TCI state.

In a sixth aspect, there is provided a method comprising: transmitting, by a network node, one or more path loss reference signal, PL-RS, samples based on at least one of sample related information or a new TCI state; transmitting, by the network node, scheduling information on the new TCI state after transmitting the one or more PL-RS samples; and receiving, by the network node, one or more uplink data based on the new TCI state.

In a seventh aspect, there is provided a computer readable medium comprising instructions stored thereon for causing an apparatus at least to perform: receiving, by the apparatus, an indication indicative of a new transmission configuration indicator, TCI, state that is activated; receiving, by the apparatus, sample related information associated with the new TCI state; receiving, by the apparatus, one or more path loss reference signal, PL-RS, samples based on at least one of the sample related information or the new TCI state; and preparing, by the apparatus, one or more uplink data based on the new TCI state, if the apparatus is ready to transmit the one or more uplink data based on the sample related information and the one or more PL-RS samples.

In an eighth aspect, there is provided a computer readable medium comprising instructions stored thereon for causing a network node at least to perform: transmitting, by the network node, an indication indicative of a new transmission configuration indicator, TCI, state that is activated; and transmitting, by the network node, sample related information associated with the new TCI state.

In a nineth aspect, there is provided a computer readable medium comprising instructions stored thereon for causing a network node at least to perform: transmitting, by the network node, one or more path loss reference signal, PL-RS, samples based on at least one of sample related information or a new TCI state; transmitting, by the network node, scheduling information on the new TCI state after transmitting the one or more PL-RS samples; and receiving, by the network node, one or more uplink data based on the new TCI state.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example of a wireless communication network;

FIG. 2 illustrates an example of dynamic indication of reduced number of TCI state switching delay;

FIG. 3 illustrates one of the signaling procedures of reducing the number of PL-RS samples for TCI state switching;

FIG. 4 illustrates one of the signaling procedures of reducing the number of PL-RS samples for TCI state switching;

FIG. 5 illustrates one of the signaling procedures of reducing the number of PL-RS samples for TCI state switching;

FIG. 6 illustrates a flowchart providing one of embodiments for reducing the number of PL-RS samples for TCI state switching;

FIG. 7 illustrates a flowchart providing one of embodiments for reducing the number of PL-RS samples for TCI state switching;

FIG. 8 illustrates a flowchart providing one of embodiments for reducing the number of PL-RS samples for TCI state switching; and

FIG. 9 illustrates an example of an apparatus comprising means for performing one or more of the example embodiments described above.

Throughout the drawings, the same or similar reference numerals may represent the same or similar element.

### DETAILED DESCRIPTION

The following embodiments are exemplifying. Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, element or characteristic, but it is not necessary that every embodiment includes the particular feature, structure, element or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, element or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a radio access network (RAN) node, a new generation RAN (NG-RAN) node, a Remote Radio Unit (RRU), a radio header (RH), a transmission and reception point (TRP), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a user device or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” “downlink resource” or “sidelink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

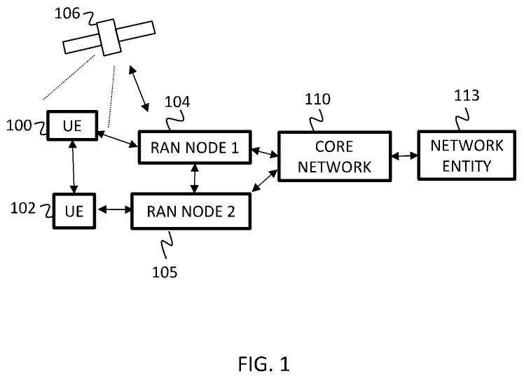

FIG. 1 illustrates an example of a simplified wireless communication network showing some physical and logical entities. The connections shown in FIG. 1 may be physical connections or logical connections. It is apparent to a person skilled in the art that the wireless communication network may also comprise other physical and logical entities than those shown in FIG. 1.

The example embodiments described herein are not, however, restricted to the wireless communication network given as an example but a person skilled in the art may apply the embodiments described herein to other wireless communication networks provided with necessary properties.

The example wireless communication network shown in FIG. 1 includes an access network, such as a radio access network (RAN), and a core network 110.

FIG. 1 shows user equipment (UE) 100, 102 configured to be in a wireless connection on one or more communication channels in a radio cell with a radio access network node (RAN node 1, 2) 104, 105 of an access network. The RAN node 104, 105 may be an evolved Node B (abbreviated as eNB or eNodeB) or a next generation Node B (abbreviated as gNB or gNodeB), providing the radio cell. The wireless connection (e.g., radio link) from a UE 100, 102 to the RAN node 104, 105 may be called uplink (UL) or reverse link, and the wireless connection (e.g., radio link) from the RAN node 104, 105 to the UE 100, 102 may be called downlink (DL) or forward link.

A UE 100 may also communicate directly with another UE 102, and vice versa, via a wireless connection generally referred to as a sidelink (SL). It should be appreciated that the RAN node 104, 105 or its functionalities may be implemented by using any node, host, server or access point etc. entity suitable for providing such functionalities.

The access network may comprise more than one RAN node 104, 105, in which case the RAN nodes 104, 105 may also be configured to communicate with one another over links, wired or wireless. These links between RAN nodes 104, 105 may be used, for example, for sending and receiving control plane signaling and also for routing data such as measurements from one RAN node 104 to another RAN node 105.

A RAN node 104, 105 may comprise a computing device configured to control the radio resources of the RAN node. The RAN node may also be referred to as a base station, a base transceiver station (BTS), an access point, an access node, a radio access node, a cell site, or any other type of node capable of being in a wireless connection with a UE (e.g., UEs 100, 102). The RAN node may include or be coupled to transceivers. From the transceivers of the RAN node, a connection may be provided to an antenna unit that establishes bi-directional radio links to UEs 100, 102. The antenna unit may comprise an antenna or antenna element, or a plurality of antennas or antenna elements.

The RAN node 104, 105 may further be connected to a core network (CN) 110. The core network 110 may comprise an evolved packet core (EPC) network and/or a 5th generation core network (5GC). The EPC may comprise network entities, such as a serving gateway (S-GW for routing and forwarding data packets), a packet data network gateway (P-GW) for providing connectivity of UEs to external packet data networks, and a mobility management entity (MME). The 5GC may comprise network functions, such as a user plane function (UPF), an access and mobility management function (AMF), and a location management function (LMF). The core network 110 may comprise a trace collection entity (TCE) and an operations and maintenance entity for supporting the MDT.

The core network 110 may also be able to communicate with one or more external network entities 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device just to mention but a few names. The UE may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or any computing device comprising a wireless modem integrated in a vehicle.

The wireless communication network may also be able to support the usage of cloud services, for example at least part of core network operations may be carried out as a cloud service. The wireless communication network may also comprise a central control entity, or the like, providing facilities for wireless communication networks of different operators to cooperate for example in spectrum sharing.

5G/6G enables using multiple input-multiple output (MIMO) antennas in the RAN node 104, 105 and/or the UE 100, 102, many more RAN nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine type applications, such as (massive) machine-type communications (mMTC), including vehicular safety, different sensors and real-time control.

In 5G wireless communication networks, RAN nodes and/or UEs may have multiple radio interfaces, namely below 6 GHz, cm Wave and mmWave, and also being integrable with existing legacy radio access technologies, such as the LTE. Integration with the LTE may be implemented, for example, as a system, where macro coverage may be provided by the LTE, and 5G radio interface access may come from small cells by aggregation to the LTE. In other words, a 5G wireless communication network may support both inter-RAT operability (such as LTE-5G) and inter-RI operability (inter-radio interface operability, such as below 6 GHz-cmWave-mmWave). One of the concepts considered to be used in 5G wireless communication networks may be network slicing, in which multiple independent and dedicated virtual sub-networks (network instances) may be created within the substantially same infrastructure to run services that have different requirements on latency, reliability, throughput and mobility.

5G may enable analytics and knowledge generation to occur at the source of the data. This approach may involve leveraging resources that may not be continuously connected to a network, such as laptops, smartphones, tablets and sensors. Multi-access edge computing (MEC) may provide a distributed computing environment for application and service hosting. It may also have the ability to store and process content in close proximity to cellular subscribers for faster response time. Edge computing may cover a wide range of technologies, such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

In some example embodiments, a RAN node 104, 105 may comprise: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example via an F1 interface. Such an embodiment of the access node may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be a logical node hosting radio resource control (RRC), service data adaptation protocol (SDAP) and/or packet data convergence protocol (PDCP), of the NR protocol stack for an access node. The DU may be a logical node hosting radio link control (RLC), medium access control (MAC) and/or physical (PHY) layers of the NR protocol stack for the access node. The operations of the DU may be at least partly controlled by the CU. It should also be understood that the distribution of functions between DU and CU may vary depending on implementation. The CU may comprise a control plane (CU-CP), which may be a logical node hosting the RRC and the control plane part of the PDCP protocol of the NR protocol stack for the access node. The CU may further comprise a user plane (CU-UP), which may be a logical node hosting the user plane part of the PDCP protocol and the SDAP protocol of the CU for the access node.

Cloud computing systems may also be used to provide the CU and/or DU. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the access network (e.g., RAN) by utilizing network function virtualization (NFV) and software defined networking (SDN). Using edge cloud may mean access node operations to be carried out, at least partly, in a computing system operationally coupled to a remote radio head (RRH) or a radio unit (RU) of an access node. It is also possible that access node operations may be performed on a distributed computing system or a cloud computing system located at the access node. Application of cloud RAN architecture enables RAN real-time functions being carried out at the access network (e.g., in a DU) and non-real-time functions being carried out in a centralized manner (e.g., in a CU).

It should also be understood that the distribution of functions between core network operations and access node operations may differ in future wireless communication networks compared to that of the LTE or 5G, or even be non-existent. Some other technology advancements that may be used include big data and all-IP, which may change the way wireless communication networks are being constructed and managed. 5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) or a 6G network may also comprise a non-terrestrial communication network, such as a satellite communication network, to enhance or complement the coverage of the 5G radio access network. For example, satellite communication may support the transfer of data between the 5G radio access network and the core network, enabling more extensive network coverage. Possible use cases may be providing service continuity for machine-to-machine (M2M) or Internet of Things (IoT) devices or for passengers on board of vehicles, or ensuring service availability for critical communications, and future railway/maritime/aeronautical communications.

Satellite communication may utilize geostationary earth orbit (GEO) satellite systems, but also low earth orbit (LEO) satellite systems, in particular mega-constellations (systems in which hundreds of (nano) satellites are deployed). A given satellite 106 in the mega-constellation may cover several satellite-enabled network entities that create on-ground cells. The on-ground cells may be created through an on-ground relay access node or by a RAN node 104, 105 located on-ground or in a satellite.

It is obvious for a person skilled in the art that the RAN nodes 104, 105 depicted in FIG. 1 are just an example of a part of an access network (e.g., a radio access network) and in practice, the access network may comprise more than two RAN nodes, the UEs 100, 102 may have access to a plurality of radio cells, and the access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of an access network (e.g., a radio access network), a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The RAN nodes 104, 105 of FIG. 1 may provide any kind of these cells. A cellular radio network may be implemented as a multilayer access networks including several kinds of radio cells. In multilayer access networks, one RAN node may provide one kind of a radio cell or radio cells, and thus a plurality of RAN nodes may be needed to provide such a multilayer access network.

For fulfilling the need for improving performance of access networks, the concept of “plug-and-play” RAN nodes may be introduced. An access network which may be able to use “plug-and-play” RAN nodes, may include, in addition to Home eNodeBs or Home gNodeBs, a Home Node B gateway, or HNB-GW (not shown in FIG. 1). An HNB-GW, which may be installed within an operator's access network, may aggregate traffic from a large number of Home eNodeBs or Home gNodeBs back to a core network of the operator.

To meet the 5G network requirements of performance and the demands of the unprecedented growth of the mobile subscribers, millions of RAN nodes (i.e., base stations) are being deployed. Such rapid growth brings the issues of optimizing the network. Artificial intelligence (AI) or machine learning (ML) techniques may be utilized to automate the optimization. For example, AI or ML may be used for the following RAN use cases: network energy saving, load balancing, and/or mobility optimization.

AI/ML based prediction may enable improved performance. For example, prediction of UE trajectory or future location may be useful to adjust handover thresholds, such as the cell individual offset or to select the RAN-based notification area (RNA) in RRC inactive mode. Prediction of UE location may further help network resource allocation for various use cases including energy saving, load balancing and mobility management. As another example, handover decisions may be improved by using prediction information on the UE performance at the target cell. Energy saving decisions taken locally at a cell may be improved by utilizing prediction information on incoming UE traffic, as well as prediction information about traffic that may be offloaded from a candidate energy saving cell to a neighbor cell ensuring coverage.

In FIG. 1, the RAN node1 104 and RAN node2 105 may be replaced by TRP1 and TRP2. In this case, a gNB may manage or control the TRP1 104 and TRP2 105, or different gNB may manage or control the TPR2 105.

### Multiple Transmit/Receive Point Operation

Hereinafter, the multiple TRP operation that may be applied to the embodiments and/or examples of the present disclosure is to be described.

In Multiple Transmit/Receive Point (multi-TRP) operation, a serving cell may schedule the UE from two TRPs, providing better coverage, reliability and/or data rates for Physical Downlink Shared Channel (PDSCH), Physical Downlink Control Channel (PDCCH), Physical Uplink Shared Channel (PUSCH), and Physical Uplink Control Channel (PUCCH).

There are two different operation modes to schedule multi-TRP PDSCH transmissions: single-Downlink control information (DCI) and multi-DCI. For both modes, control of uplink and downlink operation can be done by physical layer and MAC layer, within the configuration provided by the RRC layer. In single-DCI mode, the UE is scheduled by the same DCI for both TRPs and in multi-DCI mode, the UE is scheduled by independent DCIs from each TRP.

There are two different operation modes for multi-TRP PDCCH, such as 1) PDCCH repetition and 2) SFN based PDCCH transmission. In both modes, the UE can receive two PDCCH transmissions, one from each TRP, carrying the same DCI. In PDCCH repetition mode, the UE can receive the two PDCCH transmissions carrying the same DCI from two linked search spaces each associated with a different CORESET. In System Frame Number (SFN) based PDCCH transmission mode, the UE can receive the two PDCCH transmissions carrying the same DCI from a single search space/CORESET using different TCI states.

For multi-TRP PUSCH repetition, according to indications in a single DCI or in a semi-static configured grant provided over RRC, the UE performs PUSCH transmission of the same contents toward two TRPs with corresponding beam directions associated with different spatial relations. For multi-TRP PUCCH repetition, the UE performs PUCCH transmission of the same contents toward two TRPs with corresponding beam directions associated with different spatial relations.

For inter-cell multi-TRP operation, for multi-DCI PDSCH transmission, one or more TCI states can be associated with SSB with a PCI different from the serving cell PCI. The activated TCI states can be associated with at most one PCI different from the serving cell PCI at a time.

### TCI State Switch Delay

When a UE is requested to switch to a TCI state with the higher layer parameter DLorJointTCIState or UL-TCIstate associated to a Downlink Reference Signal (DL RS), the UE shall complete the switch of active uplink TCI state within the delay defined in clause 8.16.1 of TS38.133.

A pathloss reference signal (PL-RS) may be associated with or included in UL TCI state or joint TCI state. The requirements in this clause shall apply if the following conditions are met:
PL-RS is identical to source reference signal (RS) in UL TCI state or joint TCI state;
PL-RS and source RS in UL TCI state or joint TCI state are QCL-Type D.

The present disclosure is related to the TCI state switch functionality. One of the objectives of MIMO EVO in Rel-18 is enhancing multi-TRP operation (especially in FR2) for the cases where the UE is able to use two UL streams from two panels for simultaneous transmission to one or two receiving TRPs. The time needed by the UE to switch TCI states is specified in RAN4 requirements in the TS38.133 standard documents. These requirements are so far specified as a fixed amount of time, needed to fulfil sudden requirements in all situations and conditions.

In NR system, for example, a UE's UL transmission is controlled by an UL TCI state or a joint TCI state, which are both parts of the unified TCI framework. When a gNB is requesting the UE to start using a new UL TCI state, the gNB cannot just assume that the UE is ready to transmit until a defined “switch delay” has passed. This switch delay is specified in TS 38.133 specification document. The switch delay will ensure that the UE has enough time (e.g., under any condition) to ensure adequate measurements for beam alignment and beam correspondence. The switch delay is a maximum value, it is an upper limit.

The requirements of the TCI state switch delay shall apply for UL TCI state switch using separate UL TCI state or joint TCI state of unified TCI state switch framework.

In case that source RS in UL TCI state or joint TCI state is associated with a PCI different from that of the serving cell, the requirements shall apply if the cell with different PCI satisfies the known cell condition. If the known cell condition is not met, longer delay may be expected.

In case of joint TCI state switch, UE is not expected to transmit on UL based on the target TCI state before UE completes the DL and UL TCI state switch.

For separate UL TCI state switch or joint TCI state switch for PUCCH or PUSCH, or semi-persistent/aperiodic/periodic SRS, when beamCorrespondence WithoutUL-BeamSweeping is set to 1, upon receiving PDSCH carrying MAC-CE activation command in slot n on serving cell, if target TCI state is known, the UE may be able to transmit uplink signal with the target TCI state in the slot calculated by Formula 1, and if target TCI state is unknown, the UE may transmit uplink signal with the target TCI state in the slot calculated by Formula 2.

$$Slot n + {T}_{HARQ} + 3 {N}_{slot}^{subframe , μ} + NM * ( {T}_{first \_ target - PL - RS} + 4 * {T}_{target \_ PL - RS} + 2 ms ) / NR slot length \qquad [ Formula 1 ]$$

$$Slot n + {T}_{HARQ} + 3 {N}_{slot}^{subframe , μ} + \qquad [ Formula 2 ]$$

$$( {T}_{L 1 - RSRP} + {T}_{first \_ target - PL - RS} + 4 * {T}_{target \_ PL - RS} + 2 ms ) / NR slot length$$

The UE may transmit with the old UL TCI state until slot n+THARQ+3Nₛₗₒₜ^{subframe μ}.

Regarding Formula 1 and 2, T_{HARQ} (in slot) is the timing between downlink (DL) data transmission and acknowledgement. NM=1, if the target PL-RS is not maintained by the UE, 0 otherwise. In FR2, in case that the target PL-RS associated with or included in the target UL or joint TCI state is SSB, the requirements in this clause shall apply when this target PL-RS is maintained by the UE. T_{first_target-PL-RS} is time to first pathloss RS transmission after L1-RSRP measurement when target TCI state is unknown. T_{first_target-PL-RS} is time to first pathloss RS transmission after MAC CE command is decoded by the UE for known TCI State. T_{target_PL-RS} is the periodicity of the target pathloss reference signal which would be SSB or NZP CSI-RS when PL-RS is associated with serving cell. T_{target_PL-RS} is the periodicity of the target pathloss reference signal which would be SSB when PL-RS is associated with PCI different from serving cell. T_{L1-RSRP} is the time for Rx beam refinement in FR2. The requirements are applicable if no more than 4 different RSs are activated as PL-RS per serving cell among all active UL (or joint) TCI states.

Referring to Formula 1 and 2, the specified TCI switching delay is defined by allowing the UE time for 5 samples (e.g., T_{first_target-PL-RS}+4*T_{target_PL-RS}) of the PL-RS associated with the new UL or joint TCI state. In the embodiments of the present disclosure, the sample means one or more PL-RSs or a set of PL-RSs for calculating the switch delay.

In the Formular 1 and 2, the T_{first_target-PL-RS} is the time until the first PL-RS, and T_{target-PL-RS} is the time period of the PL-RS. In case of using a Synchronization Signal Block (SSB) as a PL-RS, the time period between the PL-RSs can be e.g., 20 ms or 40 ms due to a SSB-based RRM Measurement Timing Configuration (SMTC) window configuration.

For example, in case of e.g., 40 ms PL-RS periodicity, Formular 1 above using 5 samples will correspond to a fixed delay of more than 200 ms. This is a significant delay in dynamic scenarios e.g., UE moving and often changing UL TCI states. Furthermore, this delay may be unnecessary when UE is ready to switch but network is not aware of it, and the delay is a fixed number in the specification.

Therefore, the embodiments of the present disclosure provides methods, apparatus, computer program medium, etc. regarding how and when to enable the network (gNB) and/or the UE to dynamically configure to use less (<5) number of PL-RS samples before switching to a new joint or UL TCI state, to have a shorter switching time, while avoiding failures and/or enhance UL throughput due to faster UL scheduling.

### Dynamic Indication of Switch Delay for UL TCI State Switching

In some embodiments of the present disclosure, methods are proposed to enable the UE to optimize the time (e.g., switching delay) needed to align and synchronize to a new UL TCI state, and hence minimize the UL TCI state switching delay. As such, a gNB doesn't have to wait unnecessarily before scheduling the first UL transmission on a new TCI state.

The number of samples needed for UE to switch to a new UL TCI state may be estimated by the gNB based on requirements for UL power accuracy and/or the UE measured signal to noise ratio (SINR) of the PL-RS to be measured.

Hereinafter, various embodiments providing the dynamic indication for reducing the switch delay for the UL TCI state switching will be explained.

One of the embodiments provides methods that the UE may indicate to the gNB the preferred number of PL-RSs samples (e.g., SSB) needed with the current measured SINR. In this case, the preferred number of PL-RSs means required number of samples to achieve a RSRP measurement accuracy (below y dB). When the UE has reached the number of PL-RS samples it will additionally indicate to the gNB that UL scheduling with the new TCI state is now possible.

One of the embodiments provides methods that the gNB may indicate to the UE the number of PL-RS samples (e.g., SSBs) that the UE should measure before any UL scheduling, hence the time for first UL scheduling is known by the gNB and no additional signaling is needed.

Note that for both embodiments, the number of PL-RS samples can depend on both gNB known UL conditions for the first UL transmission, as well as on UE known DL channel conditions.

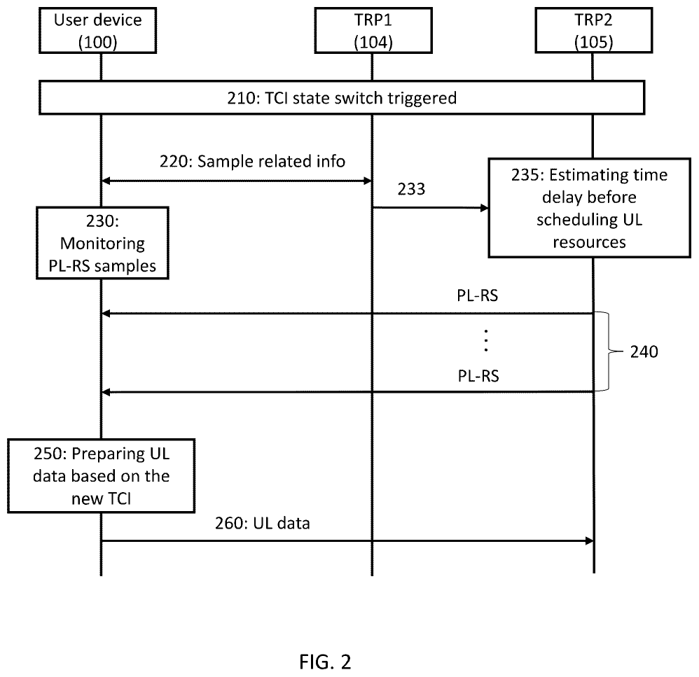

FIG. 2 illustrates an example of dynamic indication of reduced number of TCI state switching delay.

Referring to FIG. 2, the user device 100, the TRP1 104, and the TRP2 105 are disclosed. In this case, the TRP1 and TRP2 may be managed and controlled by a single gNB or separate gNBs respectively. In addition, all the procedures performed by the TRP1 and TRP2 may be performed only by the TRP1.

The ability for the gNB or the user device is to dynamically adapt the number of PL-RS samples the user device shall measure, before the user device starts first UL transmission on the new UL TCI state.

At 210, when a new TCI state has been configured, the user device 100 and a gNB may perform a TCI state switching procedure for changing the old TCI state to the new TCI state. At 210, the TCI state switching has been triggered by the network node, and the user device 100 may receive an indication indicative of a new transmission configuration indicator (TCI) state that is activated.

At 220, the user device 100 may receive sample related information associated with the new TCI state from the TRP1 104. Alternatively, the user device 100 may transmit sample related information associated with the new TCI state to the TRP1 104. If the TRP1 104 receives or determines the sample related information, then the TRP1 may transmit the sample related information to the TRP2 105, at 223.

At 230 and 240, the user device 100 may monitor the path loss reference signal (PL-RS) samples to receive one or more PL-RS samples from TRP2 105 based on at least one of the sample related information or the new TCI state.

At 250, the user device 100 may prepare one or more uplink data based on the new TCI state, if the user device 100 is ready to transmit the one or more uplink data based on the sample related information and the one or more PL-RS samples.

In some embodiments, the sample related information may include one or more conditions.

In some embodiments, the sample related information may be received via medium access control (MAC) message (or MAC CE), and the one or more conditions includes at least one of signal to noise ratio (SNR) threshold or uplink power accuracy.

In some embodiments, at 240, the user device may determine the one or more conditions are satisfied based on the received one or more PL-RS samples. In addition, the user device 100 may transmit an indication indicative of the user device is ready to transmit the uplink data with the new TCI state before phase 250.

In some embodiments, the sample related information may include one or more possible numbers of one or more PL-RS samples. In this case, the sample related information may be received via radio resource control (RRC) message.

In some embodiments, the user device 100 may transmit an indication indicative of a preferred PL-RS sample number among the one or more possible numbers. In this case, the number of preferred PL-RS samples is determined by the user device 100 based on SNR or UL power accuracy.

In some embodiments, the user device 100 may receive an indication indicative of a PL-RS sample number via the MAC message or a physical layer signaling.

In some embodiments, if the TRP1 104 receives the sample related information from the user device 100, the TRP1 104 may forward the sample related information to the TRP2 105. Then the TRP2 105 may estimate time delay for the TCI state switching before scheduling the UL resources. The TRP2 105 may transmit the UL scheduling information to the user device 100, then the user device 100 may transmit the UL data via the scheduled UL resources, at 260.

In some embodiments, if the TRP1 104 and the TRP2 105 are the same entity, then phase 233 is not performed and phases 235 and 240 may be performed by the TRP1.

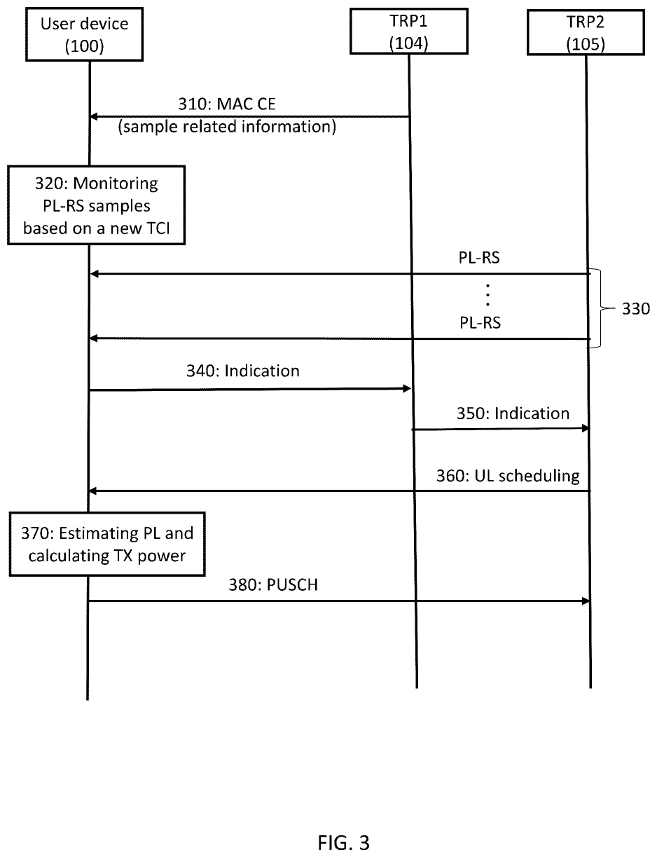

FIG. 3 illustrates one of the signaling procedures of reducing the number of PL-RS samples for TCI state switching.

In FIG. 3, the user device 100, the TRP1 104, and the TRP2 105 are disclosed. In this case, the TRP1 104 and TRP2 105 may be managed and controlled by a single gNB or separate gNBs, respectively. In addition, only one TRP (e.g., TRP1 104) may be managed and controlled by a network node (e.g., gNB).

Hereinafter, implicitly reducing the number of PL-RS samples by transmitting the sample related information including one or more conditions is explained. In this case, the one or more conditions may be set to reduce the number of PL-RS samples.

At 310, the TRP1 104 transmits a MAC CE to the user device 100 to trigger the TCI state switch. The MAC CE may include the unified TCI state activation command indicating a new TCI state is to be activated. The MAC CE indicates a new UL TCI state or joint TCI state which has been added to the list of activated TCI states. The list of the activated TCI states may be configured up to 8 codewords. The MAC CE may include sample related information associated with the new TCI state. The sample related information may include one or more conditions that are used to determine whether the user device is ready to send uplink data with the new TCI state. The one or more conditions includes at least one of a signal to noise ratio (SNR) threshold or information of uplink power accuracy.

At 320, the user device 100 starts monitoring the activated UL TCI state received via the MAC CE.

At 330, the TRP2 105 transmits one or more PL-RSs to the user device 100. The one or more PL-RSs are QCLed with the new UL TCI state. the user device 100 receives and decodes one or more PL-RSs until the one or more conditions indicated by the MAC CE are satisfied. At 330, SSBs may be used as the PL-RSs but other RS may be used for the PL-RS.

For example, the user device 100 measures the UL power accuracy or the SNR threshold by decoding each of the one or more PL-RSs. At 330, it is assumed that the number of PL-RS samples are less than 5. When the requested UL power accuracy (or the SNR threshold) is reached, the user device 100 stops decoding the PL-RS and transmits an indication indicating that the user device 100 is ready to transmit UL data on the newly activated UL TCI state, at 340. The indication indicates that the UE has receives enough samples to reach the required accuracy and that the UE is now ready to transmit the uplink data to the TRP2 105.

At 340, the indication may be transmitted via a physical uplink control channel (PUCCH), a physical uplink shared channel (PUSCH), a scheduling request (SR) message, acknowledgement message, or new UL message. In addition, the indication may include the number of PL-RS samples that the user device received and/or decoded. The number of PL-RS samples may be used by the gNB for scheduling UL resources.

At 350, the TRP1 104 may transfer the indication indicating the user device 100 is ready to transmit the UL data to the TRP2 105.

As another example, the user device 100 may transmit to TRP2 105 directly the indication indicating that the user device 100 is ready to transmit UL data on the newly activated UL TCI state.

At 360, the TRP2 105 (i.e., the gNB) may start scheduling UL data on the new UL/joint TCI state after receiving the indication. The TRP2 105 may transmit uplink scheduling information that is used for transmitting the UL data to the user device 100. The scheduling information may be included in a downlink control information (DCI) or a DL-SCH. The DCI may be transmitted via a PDCCH.

At 370, the user device 100 estimates pathloss (PL) and calculates an UL transmission power for transmitting the UL data based on the UL scheduling information and the estimated PL.

At 380, the user device 100 may transmit the UL data via a PUSCH by using the calculated UL transmission power.

The new signaling (from the user device to gNB) may indicate that the user device has measured enough PL-RS samples and such that the UE is ready to transmit the UL data using the newly activated/indicated UL TCI state.

In some embodiments, if the TRP1 104 and the TRP2 105 are the same, then phase 350 is not performed and phases 330 and 360 are performed by the TRP1. Additionally or alternatively, the TRP1 104 and the TRP2 105 may be controlled by different gNBs (e.g., gNB1 and gNB2).

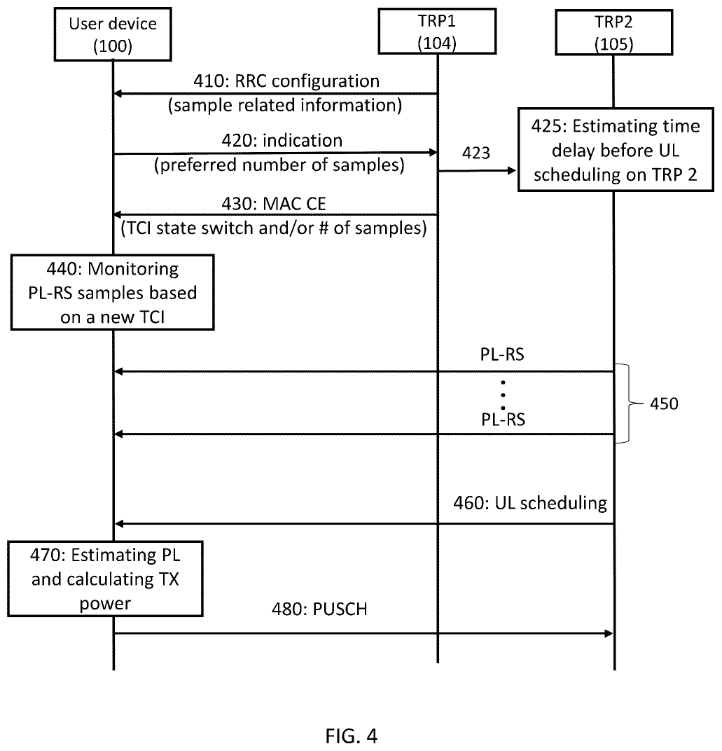

FIG. 4 illustrates one of the signaling procedures of reducing the number of PL-RS samples for TCI state switching.

In FIG. 4, the user device 100, the TRP1 104, and the TRP2 105 are disclosed. In this case, the TRP1 104 and TRP2 105 may be managed and controlled by a single gNB or separate gNBs, respectively. In addition, only one TRP (e.g., TRP1 104) may be managed and controlled by a network node (e.g., gNB).

Hereinafter, embodiments reducing the number of PL-RS samples by explicitly informing the sample related information including a possible number of PL-RS samples to be used are explained.

At 410, the TRP1 104 configures sample related information for reducing the number of PL-RS samples. The sample related information may include the number of possible PL-RS samples. The possible number of PL-RS samples may satisfy the UL power accuracy requirements, and it may be set one of 1, 2, 3, 4, and 5. In addition, the sample related information may be transmitted via a radio resource control (RRC) configuration message or a RRC information element (IE). The sample related information may further include one or more conditions including at least one of the SNR threshold or information of UL power accuracy.

In some embodiments, the possible number of PL-RS samples may be configured based on the SNR threshold or the US power accuracy. For example, when the SNR condition is good compared with the SNR threshold, the possible number of PL-RS samples may be selected as 1, 2, or 3 (or between 1 or 2). On the other hand, when the SNR condition is not so good compared with the SNR threshold, the possible number of PL-RS samples may be selected as 3, 4, or 5 (or between 4 and 5).

At 420, if the user device 100 receives the sample related information, the user device 100 may select a preferred number of PL-RS samples. For example, the user device may estimate at least one of SNR or UL power accuracy by using one or more DL-RSs in order to decide the preferred number of PL-RS samples. The DL-RSs includes one or more PL-RSs, SSBs, channel status indication reference signals (CSI-RSs), and tracking reference signals (TRSs). The user device 100 may transmit an indication indicative of the preferred number of PL-RS samples. The indication may be transmitted via a MAC message or a RRC message. The indication may be transmitted periodically with a periodicity set by the network, event triggered manner (e.g., aperiodic fashion) when the SNR or UL power accuracy is satisfied, or when the network node (e.g., the TRP1 104) requests.

At 423, the TRP1 may forward the indication of 420 to the TRP2 105. And then, at 425, the TRP2 may estimate, based on the indication, a time delay before scheduling UL resource on a cell of the TRP2. For example, the estimating of the time delay (i.e., UL switching delay time) may be performed based on the indication forwarded at 423.

At 430, the TRP1 104 may transmit to the user device 100 a MAC CE including the unified TCI state activation command indicating a new TCI state is to be activated. That is, the MAC CE indicates a new UL/joint TCI state is added to the list of activated TCI states (up to 8 codewords in the activated list).

At 440, the user device 100 starts monitoring one or more PL-RS samples based on the preferred number of PL-RS samples that are QCLed with the new UL TCI state.

At 450, the TRP2 105 transmits one or more PL-RSs to the user device 100. The one or more PL-RSs are QCLed with the new UL TCI state. The user device 100 receives and decodes one or more PL-RSs until reaching to the preferred number of PL-RS samples. The user device 100 estimates pathloss for the number of samples indicated at 420. At 450, SSBs, CSI-RSs and/or TRSs may be used as the PL-RSs but other RS may be used for the PL-RS.

At 460, the TRP2 105 (i.e., the gNB) may start scheduling UL data on the new UL/joint TCI state after estimating the UL switching delay time at 425. The TRP2 may transmit to the user device 100 uplink scheduling information that is used for transmitting the UL data. The scheduling information may be included in a downlink control information (DCI) or a DL-SCH. The DCI may be transmitted via a PDCCH.

At 470, the user device 100 estimates pathloss (PL) and calculates an UL transmission power for transmitting the UL data based on the UL scheduling information and the estimated PL.

At 480, the user device 100 may transmit the UL data via a PUSCH by using the calculated UL transmission power.

After switching to the new TCI state, the user device may keep monitoring SNR at the target TCI state and update the indication of the preferred number of PL-RS samples.

In some embodiments, if the TRP1 104 and the TRP2 105 are the same, then phase 423 is not performed and phases 425, 450 and 460 are performed by the TRP1. Additionally or alternatively, the TRP1 104 and the TRP2 105 may be controlled by different gNBs (e.g., gNB1 and gNB2).

Additionally or alternatively of the embodiments, at 430, the MAC CE may include the number of PL-RS samples decided by the TRP1 104 or TPR2 105 (or the gNB). In this case, the TRP1 104 decides the reduced number of PL-RS in consideration of the received indication from the user device 100. Alternatively, the TPR2 105 may receive the indication indicative of the preferred number of PL-RS samples at 425 and then, the TRP2 105 may decide the reduced number of PL-RS samples in consideration of the estimated time delay. After that, the TRP2 105 transmits the reduced number of PL-RS samples to the TRP1 and/or the user device 100. Alternatively or additionally, the TRP1 104 may schedule the UL grant for the user device 100 such that the user device 100 is able to transmit the UL data to the TRP2 105. Then, the TRP1 104 may transmit the UL grant to the user device 100 and the TRP2 105.

If the user device 100 receives the reduced number of PL-RS samples at 430, the user device 100 receives and decodes the PL-RS samples according to the reduced number of PL-RS samples at 440 and 450.

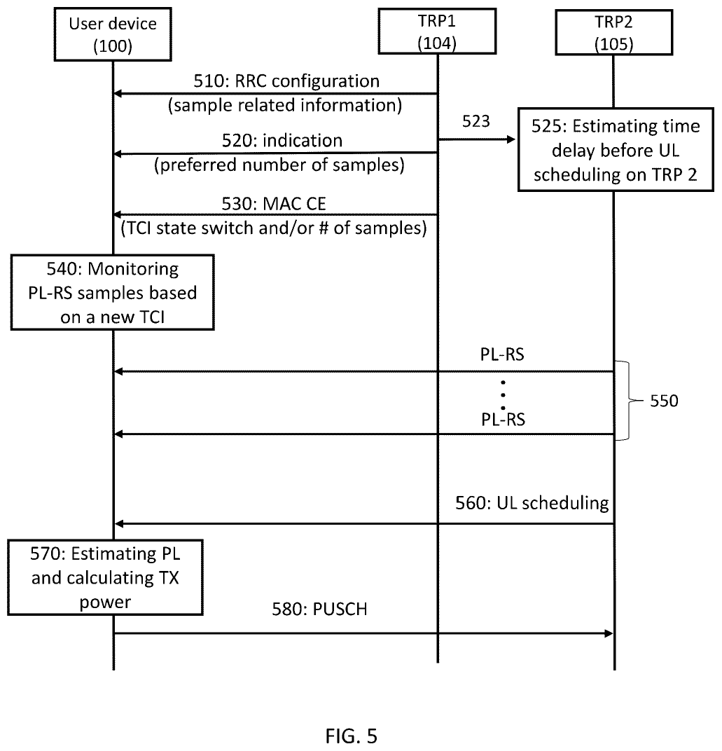

FIG. 5 illustrates one of the signaling procedures of reducing the number of PL-RS samples for TCI state switching.

The embodiments explained by FIG. 5 are similar to the embodiments explained by FIG. 4. Thus, the different phases of FIG. 5 will be explained hereinafter and other same or similar phases can be referred to the corresponding phases of FIG. 4.

At 510, the TRP1 104 configures sample related information for reducing the number of PL-RS samples. The sample related information may include the number of possible PL-RS samples. The possible number of PL-RS samples may satisfy the UL power accuracy requirements or SNR threshold, and it may be set one of 1, 2, 3, 4, and 5. In this case, the sample related information may be transmitted to the user device via a radio resource control (RRC) configuration message or a RRC information element (IE) together with the new TCI state. The sample related information may further include one or more conditions including at least one of the SNR threshold or information of UL power accuracy.

At 520, the TRP1 104 may decide the reduced number of PL-RS samples based on either UL channel condition for the new TCI state and/or a possible reported UE DL quality measurement of the DL-RS associated to the new TCI state. And then, the TRP1 104 may transmit an indication indicative of the reduced number of PL-RS samples.

In some embodiments, the indication may be transmitted via a MAC message or a physical layer signaling (e.g., DCI) at 520. That is to say, the possible number of the PL-RS samples are configured as a semi-statically and the reduced number of PL-RS samples are dynamically configured.

At 523, the TRP1 may forward the indication of 520 to the TRP2 105. And then, at 525, the TRP2 may estimate, based on the indication, a time delay before scheduling UL resource on a cell of the TRP2. For example, the estimating of the time delay (i.e., UL switching delay time) may be performed based on the indication forwarded at 523.

At 530, the TRP1 104 may transmit to the user device 100 a MAC CE including the unified TCI state activation command indicating a new TCI state is to be activated. That is, the MAC CE indicates a new UL/joint TCI state is added to the list of activated TCI states (up to 8 codewords in the activated list).

In some other embodiments, the MAC message of 520 may be the same as the MAC CE of 530. Or phase 530 may not be performed and the TCI activation command may be transmitted via the MAC message of 520.

At 540, the user device 100 starts monitoring one or more PL-RS samples based on the reduced number of PL-RS samples indicated by the indication of 520.

The explanations of phases 540 to 580 can be referred to the explanations of phases 440 to 480.

In some embodiments, if the TRP1 104 and the TRP2 105 are the same, then phase 523 is not performed and phases 525, 550, 560, and 580 may be performed by the TRP1.

According to the current system, the TCI state switching takes up to 5 PL-RS sampling periods. However, using the solutions of FIGS. 3 to 5, the switch delay can be significantly reduced. For example, if the PL-RS is the SSB, the time period between the SSBs is 20 ms (or 40 ms), and the reduced number of PL-RS samples is 3, then the required switch delay can be reduced more than 60 ms (or 120 ms).

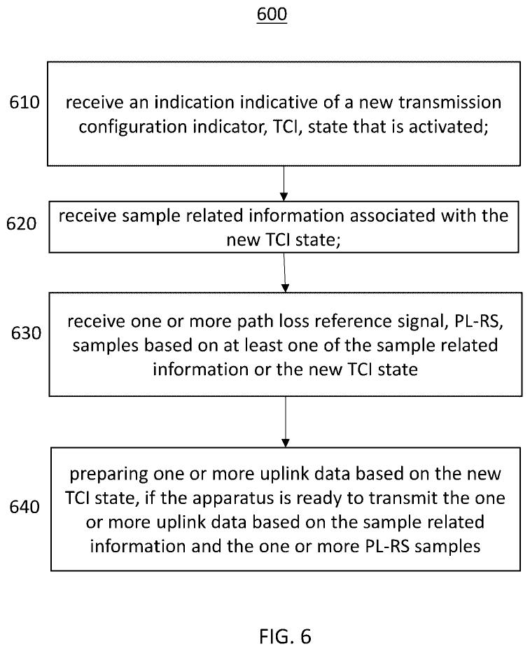

FIG. 6 illustrates a flowchart providing one of embodiments for reducing the number of PL-RS samples for TCI state switching.

Referring to FIG. 6, the method comprising steps of: receiving, by a user device, an indication indicative of a new transmission configuration indicator, TCI, state that is activated; receiving, by the user device, sample related information associated with the new TCI state; receiving, by the user device, one or more path loss reference signal, PL-RS, samples based on at least one of the sample related information or the new TCI state; and preparing, by the user device, one or more uplink data based on the new TCI state, if the user device is ready to transmit the one or more uplink data based on the sample related information and the one or more PL-RS samples.

In some exemplary embodiments, the user device is the user device 100 of FIGS. 2 to 5.

In some exemplary embodiments, the sample related information may include one or more conditions.

In some exemplary embodiments, the sample related information may be received via medium access control, MAC, message, and the one or more conditions may include at least one of signal to noise ratio, SNR, threshold or uplink power accuracy.

In some exemplary embodiments, the method may further comprise steps of: determining the one or more conditions are satisfied based on the received one or more PL-RS samples; and causing to transmit an indication indicative of the apparatus is ready to transmit the uplink data with the new TCI state.

In some exemplary embodiments, the sample related information may include one or more possible numbers of one or more PL-RS samples, and the sample related information may be received via radio resource control, RRC, message.

In some exemplary embodiments, the method may further comprise step of transmitting an indication indicative of a preferred PL-RS sample number among the one or more possible numbers.

In some exemplary embodiments, the method may further comprise a step of receiving an indication indicative of a PL-RS sample number.

In some exemplary embodiments, the sample related information may include an indication indicative of a PL-RS sample number.

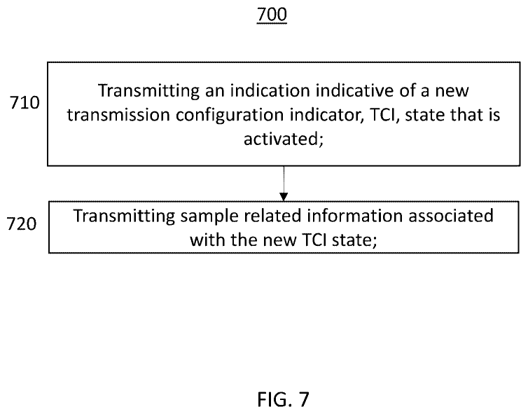

FIG. 7 illustrates a flowchart providing one of embodiments for reducing the number of PL-RS samples for TCI state switching.

Referring to FIG. 7, the method comprises steps of: transmitting, by a network node, an indication indicative of a new transmission configuration indicator, TCI, state that is activated; and transmitting, by the network node, sample related information associated with the new TCI state.

In some exemplary embodiments, the network node may be the TRP1 104 of one of FIGS. 2 to 5 or a gNB.

In some exemplary embodiments, the sample related information may include one or more conditions.

In some exemplary embodiments, the sample related information may be received via medium access control, MAC, message, and the one or more conditions may include at least one of signal to noise ratio (SNR) threshold or uplink power accuracy.

In some exemplary embodiments, the sample related information may include one or more possible numbers of one or more PL-RS samples, and wherein the sample related information may be transmitted via radio resource control, RRC, message.

In some exemplary embodiments, the method may further comprise a step of receiving an indication indicative of a preferred PL-RS sample number among the one or more possible numbers.

In some exemplary embodiments, the method may further comprise a step of transmitting an indication indicative of a PL-RS sample number.

In some exemplary embodiments, the sample related information may include an indication indicative of a PL-RS sample number.

In some exemplary embodiments, the method may further comprise steps of transmitting one or more path loss reference signal (PL-RS) samples based on at least one of the sample related information or the new TCI state; transmitting scheduling information on the new TCI state after transmitting the one or more PL-RS samples; and receiving one or more uplink data based on the new TCI state.

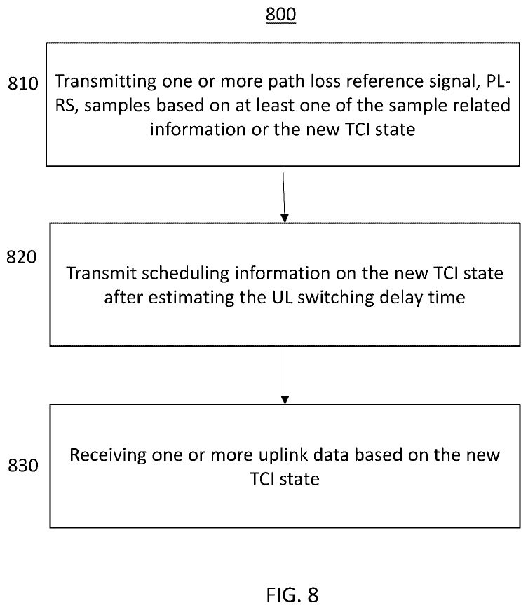

FIG. 8 illustrates a flowchart providing one of embodiments for reducing the number of PL-RS samples for TCI state switching.

Referring to FIG. 8, the method comprises steps of: transmitting, by a network node, one or more path loss reference signal, PL-RS, samples based on at least one of sample related information or a new TCI state; transmitting, by the network node, scheduling information on the new TCI state after transmitting the one or more PL-RS samples; and receiving, by the network node, one or more uplink data based on the new TCI state.

In some exemplary embodiments, the network node may be the TRP2 105 of one of FIGS. 2 to 5 or a gNB.

In some exemplary embodiments, the method may further comprise the steps of receiving an indication indicative of preferred number of PL-RS samples; and estimating time delay for transmitting the scheduling information on the new TCI state based on the indication.

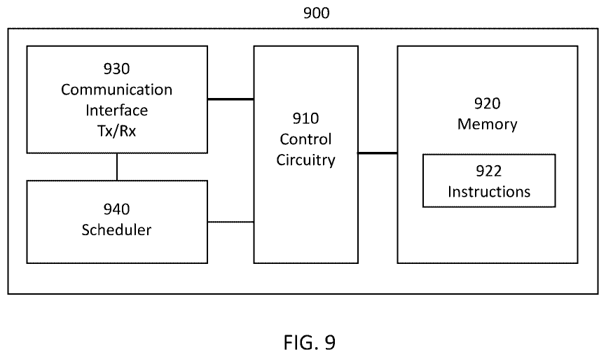

FIG. 9 illustrates an example of an apparatus 900 comprising means for performing one or more of the example embodiments described above. For example, the apparatus 900 may be an apparatus such as, or comprising, or comprised in, the network entity 113, the RAN 104, or the user device 100, and support the embodiments described above.

The RAN node 104 may also be referred to, for example, as a network element, a next generation radio access network (NG-RAN) node, a NodeB, an eNB, a gNB, a base transceiver station (BTS), a base station, an NR base station, a 5G base station, an access node, an access point (AP), a cell site, a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 900 may comprise, for example, a circuitry or a chipset applicable for realizing one or more of the example embodiments described above. The apparatus 900 may be an electronic device comprising one or more electronic circuitries. The apparatus 900 may comprise a communication control circuitry 910 such as at least one processor, and at least one memory 920 storing instructions 922 which, when executed by the at least one processor, cause the apparatus 900 to carry out one or more of the example embodiments described above, such as the embodiments explained by FIGS. 2 to 8 and the description thereof. Such instructions 922 may, for example, include computer program code (software). The at least one processor and the at least one memory storing the instructions may provide the means for providing or causing the performance of any of the methods and/or blocks described above.

The processor is coupled to the memory 920. The processor is configured to read and write data to and from the memory 920. The memory 920 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable medium. The term “non-transitory,” as used herein, is a limitation of the medium itself (i.e., tangible, not a signal) as opposed to a limitation on data storage persistency (e.g., RAM vs. ROM). The memory 920 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 920 or, alternatively or additionally, they may be received, by the apparatus, via an electromagnetic carrier signal and/or may be copied from a physical entity such as a computer program product. Execution of the computer readable instructions causes the apparatus 900 to perform one or more of the functionalities described above.

The memory 920 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbour cell list, and, in some example embodiments, structures of frames used in the detected neighbour cells.

In some example embodiments a non-transitory computer readable medium may be provided. The non-transitory computer readable medium may comprise instructions to perform the embodiments explained in FIGS. 2 to 8 and the description thereof.

As one example, the non-transitory computer readable medium may comprise program instructions which, when executed by an apparatus, cause the apparatus to perform at least the following: receiving an indication indicative of a new transmission configuration indicator, TCI, state that is activated; receiving sample related information associated with the new TCI state; receiving one or more path loss reference signal, PL-RS, samples based on at least one of the sample related information or the new TCI state; and preparing one or more uplink data based on the new TCI state, if the apparatus is ready to transmit the one or more uplink data based on the sample related information and the one or more PL-RS samples.

As the other example, a non-transitory computer readable medium may be provided. The non-transitory computer readable medium may comprise program instructions which, when executed by an apparatus, cause the apparatus to perform at least the following: transmitting an indication indicative of a new transmission configuration indicator, TCI, state that is activated; and transmitting sample related information associated with the new TCI state.

As still the other example, a non-transitory computer readable medium may be provided. The non-transitory computer readable medium may comprise program instructions which, when executed by an apparatus, cause the apparatus to perform at least the following: transmitting one or more path loss reference signal, PL-RS, samples based on at least one of sample related information or a new TCI state; transmitting scheduling information on the new TCI state after transmitting the one or more PL-RS samples; and receiving one or more uplink data based on the new TCI state.

Referring back to FIG. 9, the apparatus 900 may further comprise or be connected to a communication interface 930, such as a radio unit, comprising hardware and/or software for realizing communication connectivity with one or more wireless communication devices according to one or more communication protocols. The communication interface 930 comprises at least one transmitter (Tx) and at least one receiver (Rx) that may be integrated to the apparatus 900 or that the apparatus 900 may be connected to. The communication interface 930 may provide means for performing some of the blocks for one or more example embodiments described above. The communication interface 930 may comprise one or more components, such as: power amplifier, digital front end (DFE), analog-to-digital converter (ADC), digital-to-analog converter (DAC), frequency converter, (de) modulator, and/or encoder/decoder circuitries, controlled by the corresponding controlling units.

The communication interface 930 provides the apparatus with radio communication capabilities to communicate in the wireless communication network. The communication interface may, for example, provide a radio interface to one or more wireless communication devices. The apparatus 900 may further comprise or be connected to another interface towards a core network such as the network coordinator apparatus or AMF, and/or to the access nodes of the wireless communication network.

The apparatus 900 may further comprise a scheduler 940 that is configured to allocate radio resources. The scheduler 940 may be configured along with the communication control circuitry 910 or it may be separately configured.

It is to be noted that the apparatus 900 may further comprise various components not illustrated in FIG. 9. The various components may be hardware components and/or software components.

The explained embodiments above may cover the following use cases:
Single TRP joint/UL TCI switching,
MTRP inter cell master DCI (mDCI),
MTRP intra cell secondary DCI (sDCI): switching TCI between the TRP1 and the TRP2 of the same cell),
MTRP intra cell (mDCI: Similar to two parallel Single TRP TCI switching), and/or
ICBM (Inter Cell Beam Management) TCI switching between cells.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the embodiments.

1.-31. (canceled)

32. An apparatus comprising:
means for causing to receive an indication indicative of a new transmission configuration indicator, TCI, state that is activated;
means for causing to receive sample related information associated with the new TCI state;
means for causing to receive one or more path loss reference signal, PL-RS, samples based on at least one of the sample related information or the new TCI state; and
means for preparing one or more uplink data based on the new TCI state, if the apparatus is ready to transmit the one or more uplink data based on the sample related information and the one or more PL-RS samples.

33. The apparatus according to claim 32, wherein the sample related information includes one or more conditions.

34. The apparatus according to claim 33, wherein, the one or more conditions includes at least one of signal to noise ratio, SNR, threshold or uplink power accuracy.

35. The apparatus according to claim 33, further comprising:
means for determining the one or more conditions are satisfied based on the received one or more PL-RS samples; and
means for causing to transmit an indication indicative of the apparatus is ready to transmit the uplink data with the new TCI state.

36. The apparatus according to claim 32, wherein the sample related information includes one or more possible numbers of one or more PL-RS samples, and wherein the sample related information is received via radio resource control, RRC, message.

37. The apparatus according to claim 36, further comprising:
means for causing to transmit an indication indicative of a preferred PL-RS sample number among the one or more possible numbers.

38. The apparatus according to claim 32, further comprising:
means for causing to receive an indication indicative of a PL-RS sample number.

39. The apparatus according to claim 32, wherein the sample related information includes an indication indicative of a PL-RS sample number.

40. An apparatus comprising:
means for causing to transmit an indication indicative of a new transmission configuration indicator, TCI, state that is activated; and
means for causing to transmit sample related information associated with the new TCI state.

41. The apparatus according to claim 40, wherein the sample related information includes one or more conditions.

42. The apparatus according to claim 41, wherein the one or more conditions includes at least one of signal to noise ratio, SNR, threshold or uplink power accuracy.

43. The apparatus according to claim 40, wherein the sample related information includes one or more possible numbers of one or more PL-RS samples, and wherein the sample related information is transmitted via radio resource control, RRC, message.

44. The apparatus according to claim 40, further comprising:
means for causing to receive an indication indicative of a preferred PL-RS sample number among the one or more possible numbers.

45. The apparatus according to claim 40, further comprising:
means for causing to transmit an indication indicative of a PL-RS sample number.

46. The apparatus according to claim 40, wherein the sample related information includes an indication indicative of a PL-RS sample number.

47. The apparatus according to claim 40, further comprising:
means for causing to transmit one or more path loss reference signal, PL-RS, samples based on at least one of the sample related information or the new TCI state;
means for causing to transmit scheduling information on the new TCI state after transmitting the one or more PL-RS samples; and
means for receiving one or more uplink data based on the new TCI state.

48. An apparatus, comprising:
means for causing to transmit one or more path loss reference signal, PL-RS, samples based on at least one of sample related information or a new TCI state;
means for causing to transmit scheduling information on the new TCI state after transmitting the one or more PL-RS samples; and
means for receiving one or more uplink data based on the new TCI state.

49. The apparatus according to claim 48, comprising:
means for receiving an indication indicative of preferred number of PL-RS samples; and
means for estimating time delay for transmitting the scheduling information on the new TCI state based on the indication.
